(19) United States
(12) Patent Application Publication
(10) Pub. No.: US 2024/0241341 A1
(43) Pub. Date: Jul. 18, 2024

(54) LENS UNIT AND IMAGING DEVICE

(71) Applicant: KYOCERA Corporation, Kyoto (JP)

(72) Inventors: Takaharu FUJII, Tokorozawa-shi, Saitama (JP); Takashi SAOTOME, Kirishima-shi, Kagoshima (JP); Satoru KIHARA, Akishima-shi, Tokyo (JP); Akihiro KAIZUKA, Ome-shi, Tokyo (JP)

(73) Assignee: KYOCERA Corporation, Kyoto (JP)

(21) Appl. No.: 18/562,015

(22) PCT Filed: May 26, 2022
(86) PCT No.: PCT/JP2022/021645

§ 371 Date: Nov. 17, 2023

(30) Foreign Application Priority Data
May 27, 2021 (JP) 2021-089572

(51) Int. Cl. G02B 7/02; H04N 23/55

(52) U.S. Cl. CPC G02B 7/028; H04N 23/55

(57) ABSTRACT

A lens unit includes a lens, a frame, a barrel housing the frame therein and is connectable to a substrate for mounting an imaging element, and a temperature compensation member including first and second portions apart from each other in an optical-axis parallel direction. The temperature compensation member is in contact with the barrel at the first portion and with the frame at the second portion. The frame is movable in the optical-axis parallel direction with respect to the barrel. The length of extension in the optical-axis parallel direction per unit temperature of a part of the temperature compensation member between the first and second portions differs from the length of extension in the optical-axis parallel direction per unit temperature of a part of the barrel closer to a barrel side connected to the substrate than a part of the barrel in contact with the first portion.

### CROSS-REFERENCE TO RELATED APPLICATIONS

The present application claims priority from JP Application Serial Number 2021-89572, filed May 27, 2021, the disclosure of which is hereby incorporated by reference herein in its entirety.

### TECHNICAL FIELD

The present disclosure relates to a lens unit and an imaging device.

### BACKGROUND OF INVENTION

A known optical sensor includes a lens (for example, see Patent Literature 1).

### CITATION LIST

### Patent Literature

Patent Literature 1: Japanese Unexamined Patent Application Publication No. 2020-140177

### SUMMARY

In an embodiment of the present disclosure, a lens unit includes a lens that has an optical axis, a lens frame holding the lens, a lens barrel, and a temperature compensation member. The lens barrel has a central axis along the optical axis, houses the lens frame on an inner circumferential side, and is connectable to a substrate on which an imaging element is mounted. The temperature compensation member includes a first portion and a second portion that are apart from each other in a direction parallel to the optical axis. The first portion of the temperature compensation member is in contact with the lens barrel and the second portion of the temperature compensation member is in contact with the lens frame. By the lens frame being connected to the lens barrel via the temperature compensation member, the lens frame is movable in a direction parallel to the optical axis with respect to the lens barrel when a length of the temperature compensation member in the direction parallel to the optical axis changes. A length of extension in the direction parallel to the optical axis per unit temperature of a part of the temperature compensation member from the first portion to the second portion differs from a length of extension in the direction parallel to the optical axis per unit temperature of a part of the lens barrel closer to a lens barrel side connected to the substrate than a part of the lens barrel in contact with the first portion of the temperature compensation member.

In an embodiment of the present disclosure, an imaging device includes a lens unit and a substrate on which an imaging element is mounted. The lens unit includes a lens including an optical axis, a lens frame holding the lens, a lens barrel, and a temperature compensation member. The lens barrel has a central axis along the optical axis, houses the lens frame on an inner circumferential side, and is connectable to the substrate on which an imaging element is mounted. The temperature compensation member includes a first portion and a second portion that are apart from each other in a direction parallel to the optical axis. The first portion of the temperature compensation member is in contact with the lens barrel and the second portion of the temperature compensation member is in contact with the lens frame. By the lens frame being connected to the lens barrel via the temperature compensation member, the lens frame is movable in the direction parallel to the optical axis with respect to the lens barrel when a length of the temperature compensation member in the direction parallel to the optical axis changes. A length of extension in the direction parallel to the optical axis per unit temperature of a part of the temperature compensation member from the first portion to the second portion differs from a length of extension in the direction parallel to the optical axis per unit temperature of a part of the lens barrel closer to a lens barrel side connected to the substrate than a part of the lens barrel in contact with the first portion of the temperature compensation member.

### BRIEF DESCRIPTION OF THE DRAWINGS

FIG. 1 is a sectional view illustrating a structure example of an imaging device according to an embodiment.

FIG. 2 is an enlarged view of the area enclosed by the dash line in FIG. 1.

FIG. 3 is a diagram illustrating another structure example of a temperature adjustment member.

FIG. 4 is a diagram illustrating a structure example containing two lenses.

FIG. 5 is a diagram illustrating a structure example in which a connection direction of the temperature adjustment member differs.

### DESCRIPTION OF EMBODIMENTS

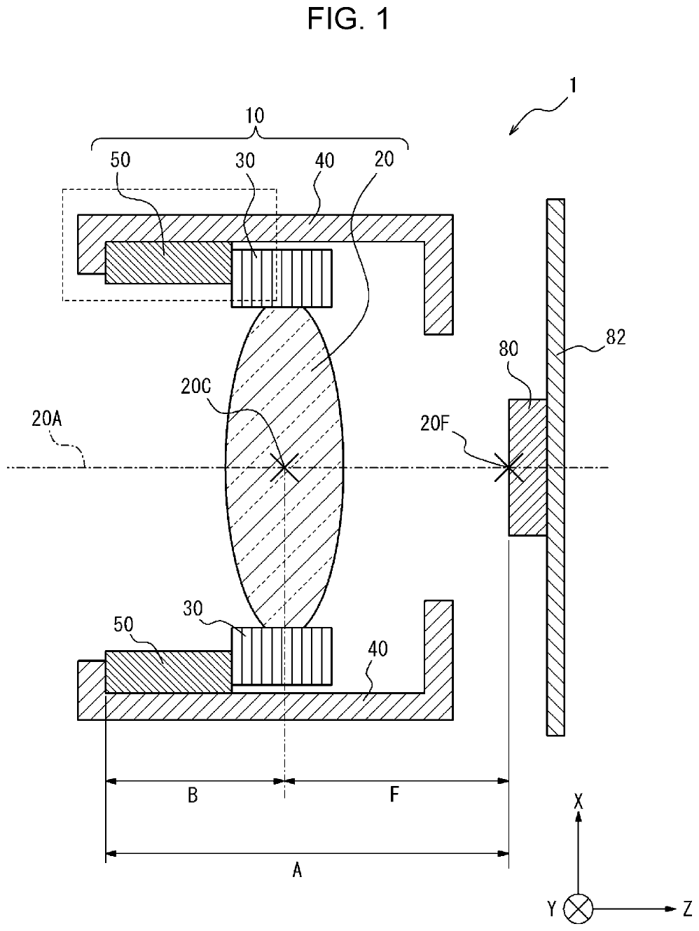

As illustrated in FIG. 1, an imaging device 1 according to an embodiment includes a lens unit 10 and an imaging element 80. The lens unit 10 includes a lens 20, a lens frame 30, a lens barrel 40, and a temperature compensation member 50. The lens 20 has an optical axis 20A that connects a lens center 20C and a focus 20F to each other. The optical axis 20A is assumed to extend in a Z-axis direction. Light from the subject of the imaging device 1 is incident on the lens 20 from the opposite side of the focus 20F. The light from the subject is focused on a focal plane including the focus 20F. The distance from the lens center 20C to the focus 20F is represented as a focal length F.

The lens frame 30 holds the lens 20. The lens barrel 40 is formed in a cylindrical shape having a central axis parallel to the optical axis 20A and houses the lens 20 and the lens frame 30 on the inner circumferential side of the cylindrical structure. The temperature compensation member 50 connects the lens frame 30 and lens barrel 40 to each other.

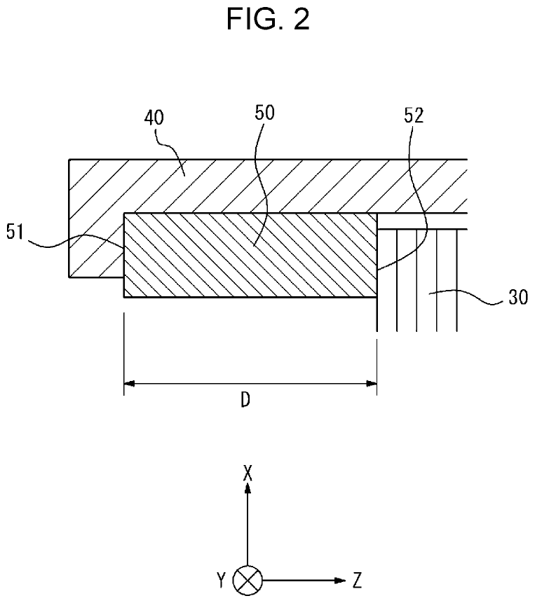

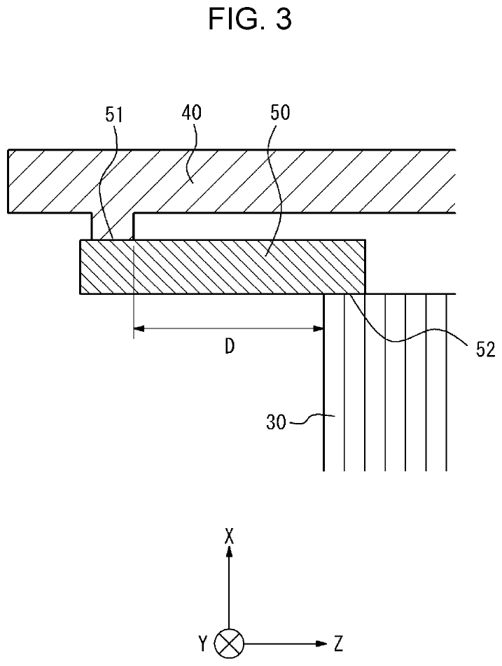

As illustrated in FIGS. 2 and 3, the temperature compensation member 50 includes a first portion 51 in contact with the lens barrel 40 and a second portion 52 in contact with the lens frame 30. The first portion 51 and the second portion 52 are apart from each other in a direction parallel to the optical axis 20A. The temperature compensation member 50 is fixed to the lens barrel 40 at the first portion 51 and fixed to the lens frame 30 at the second portion 52. The temperature compensation member 50 defines the positional relationship between the lens barrel 40 and the lens frame 30 by connecting the lens barrel 40 and the lens frame 30 to each other. Specifically, the temperature compensation member 50 defines the distance in the Z-axis direction between the position at which the lens barrel 40 is in contact with the first portion 51 and the position at which the lens frame 30 is in contact with the second portion 52. The distance in the Z-axis direction between the position at which the lens barrel 40 is in contact with the first portion 51 and the position at which the lens frame 30 is in contact with the second portion 52 is represented by D.

In other words, the lens frame 30 is connected to the lens barrel 40 via the temperature compensation member 50. The lens frame 30 moves in the Z-axis direction with respect to lens barrel 40 when the length of the temperature compensation member 50 in the Z-axis direction changes. That is, the lens frame 30 is movable in the Z-axis direction with respect to the lens barrel 40.

In FIG. 2, the first portion 51 and the second portion 52 are planes parallel to the XY plane. That is, at least one selected from the group consisting of the first portion 51 and the second portion 52 may be a plane that intersects the Z-axis direction corresponding to the direction parallel to the optical axis 20A. The distance between the plane corresponding to the first portion 51 and the plane corresponding to the second portion 52 is represented by D. In FIG. 3, the first portion 51 and the second portion 52 are planes parallel to the YZ plane. That is, the first portion 51 and the second portion 52 may be planes (planes that do not intersect the Z-axis direction) parallel to the Z-axis direction corresponding to the direction parallel to the optical axis 20A. The distance in the Z-axis direction between an end portion of the first portion 51 on the positive side of the Z-axis and an end portion of the second portion 52 on the negative side of the Z-axis is represented by D.

The imaging element 80 is assumed to be mounted on a substrate 82. The imaging element 80 is disposed such that the focus 20F of the lens 20 is located on the imaging surface of the imaging element 80. In other words, the imaging element 80 is disposed such that the imaging surface thereof is separated from the lens center 20C by the focal length F. When the focus 20F is located on the imaging surface, the imaging element 80 can take an in-focus image. The lens barrel 40 is connectable to the substrate 82. The positional relationship between the lens 20 and the imaging element 80 is defined by connecting the lens barrel 40 to the substrate 82.

When the temperature of the lens 20 itself or the temperature around the lens 20 changes, the focal length F of the lens 20 changes. For example, the higher the temperature, the longer the focal length F of the lens 20 may become. Conversely, the higher the temperature, the shorter the focal length F of the lens 20 may become. For example, the focal length F may change when the lens 20 itself deforms in response to a temperature change. The focal length F may change when the refractive index of a material of the lens 20 changes in response to a temperature change. The focal length F may change in accordance with various other factors in response to a temperature change, in addition to the factors described above. Even when the imaging element 80 is disposed such that the focus 20F of the lens 20 is located on the imaging surface of the imaging element 80 at a predetermined temperature, the focus 20F deviates in the Z-axis direction from the imaging surface when the focal length F changes because the temperature changes from the predetermined temperature.

The positional relationship between the lens unit 10 and the imaging element 80 in the imaging device 1 illustrated in FIG. 1 assumes that the temperature of the environment in which the imaging device 1 is placed is the predetermined temperature. In FIG. 1, the distance in the Z-axis direction between a portion of the lens barrel 40 in contact with the first portion 51 of the temperature compensation member 50 and the imaging surface of the imaging element 80 is represented by A. The distance in the Z-axis direction between a portion of the lens barrel 40 in contact with the first portion 51 of the temperature compensation member 50 and the lens center 20C of the lens 20 is represented by B. In this case, the equation F=A−B holds. That is, when the equation F=A−B holds, the focus 20F is located on the imaging surface of the imaging element 80 in the imaging device 1. In the lens unit 10, the focus 20F of the lens 20 may be formed on the imaging surface of the imaging element 80 at least at the predetermined temperature when the lens barrel 40 is connected to the substrate 82.

Here, when the temperature of the environment in which the imaging device 1 is placed changes from the predetermined temperature, the focal length F may change. The change in the focal length F deviates the focus 20F in the Z-axis direction from the imaging surface of the imaging element 80. However, since the distance represented by A or B changes to satisfy the equation F=A−B in the lens unit 10, the state in which the focus 20F is located on the imaging surface of the imaging element 80 can be maintained even when the temperature changes. Even when the equation F=A−B does not hold, the distance by which the focus 20F deviates from the imaging surface is reduced when A or B changes such that the value of (A−B) approaches F.

In the lens unit 10, the value of A corresponds to the sum of the length of the lens barrel 40 in the Z-axis direction and the distance from the end portion of the lens barrel 40 on the positive side of the Z-axis to the imaging surface of the imaging element 80. Accordingly, the amount of change in the value of A in response to a temperature change includes the amount of change in the length of the lens barrel 40 in the Z-axis direction in response to the temperature change. The amount of change in the length of the lens barrel 40 in the Z-axis direction in response to a temperature change is determined in accordance with the original length (length at the predetermined temperature) of the lens barrel 40 in the Z-axis direction and the linear expansion coefficient in the Z-axis direction of the lens barrel 40.

The value of B corresponds to the sum of the length of a portion of the temperature compensation member 50 from the first portion 51 to the second portion 52 in the Z-axis direction and the distance from the second portion 52 of the temperature compensation member 50 to the lens center 20C. Accordingly, the amount of change in the value of B in response to a temperature change includes the amount of change in the length of the temperature compensation member 50 in the Z-axis direction in response to the temperature change. The amount of change in the length of the temperature compensation member 50 in the Z-axis direction in response to a temperature change is determined in accordance with the original length (length at the predetermined temperature) of the temperature compensation member 50 in the Z-axis direction and the linear expansion coefficient in the Z-axis direction of the temperature compensation member 50.

The amount of change in temperature is represented as ΔT. When the temperature rises, ΔT>0 is assumed to hold. When the temperature falls, ΔT<0 is assumed to hold. In the embodiment, the amount of change in the value of A when the temperature changes by ΔT from the predetermined temperature is assumed to be ΔA. The amount ΔA corresponds to the length of extension in the Z-axis direction per unit temperature of a part of the lens barrel 40 closer to a lens barrel 40 side (positive side of the Z-axis) connected to the substrate 82 than a part of the lens barrel 40 in contact with the first portion 51 of the temperature compensation member 50. The sign of ΔA is assumed to be positive when A extends in the positive direction of the Z-axis with respect to the position of the first portion 51 as the reference. In the example in FIG. 1, ΔA>0 is assumed to hold when ΔT>0. The amount of change in the value of B is assumed to be ΔB. When ΔT is a unit temperature, ΔB corresponds to the length of extension in the Z-axis direction per unit temperature of a part of the temperature compensation member 50 from the first portion 51 to the second portion 52. The sign of ΔB is assumed to be positive when B extends in the positive direction of the Z-axis with respect to the position of the first portion 51 as the reference. In the example in FIG. 1, ΔB>0 is assumed to hold when ΔT>0. The amount of change in the focal length F when the temperature changes by ΔT from the predetermined temperature is assumed to be ΔF. The sign of ΔF is assumed to be positive when the focal length F becomes longer. The sign of ΔF when the temperature rises is determined in accordance with the structure of the lens 20 and can be either positive or negative.

The amount ΔA is determined in accordance with the linear expansion coefficient in the Z-axis direction of the lens barrel 40 and the value of A. The amount ΔB is determined in accordance with the linear expansion coefficient in the Z-axis direction of the temperature compensation member 50 and the value of B. The amount ΔF is determined in accordance with the structure of the lens 20.

When the focal length F changes by ΔF because the temperature changes by ΔT, the focus 20F deviates from the imaging surface of the imaging element 80 in the positive or negative direction of the Z-axis when the lens center 20C does not move. Conversely, since the position of the lens center 20C moves by −ΔF in the Z-axis direction when the focal length F changes by ΔF, the focus 20F can be located on the imaging surface of the imaging element 80 even when the temperature changes. The lens center 20C moves in the negative direction of the Z-axis when A increases or in the positive direction of the Z-axis when B increases. Thus, the amount of movement of the position of the lens center 20C is represented by ΔB−ΔA. Since the lens center 20C moves in the Z-axis direction by −ΔF consequently, the equation ΔF=ΔA−ΔB need hold.

Conversely, by forming the lens unit 10 to satisfy the equation ΔF=ΔA−ΔB, the focus 20F can be located on the imaging surface of the imaging element 80 even when the temperature changes by ΔT. Since the lens unit 10 is formed such that the absolute value of the difference between ΔF and (ΔA−ΔB) is less than or equal to a predetermined value even when the equation ΔF=ΔA−ΔB does not hold, the focus 20F can be located within a predetermined distance from the imaging surface of the imaging element 80 even when the temperature changes by ΔT. Since the focus 20F can be located on the imaging surface of the imaging element 80 or located within a predetermined distance from the imaging surface even when the temperature changes by ΔT, the focus performance of the imaging device 1 is less likely to be affected by a temperature change.

The conditions necessary for the equation ΔF=ΔA−ΔB to hold or for the absolute value of the difference between ΔF and (ΔA−ΔB) to be equal to or less than a predetermined value are also referred to as temperature stability conditions. When ΔF=0, the temperature stability conditions are met by satisfying ΔA=ΔB. When ΔF+0, the temperature stability conditions include ΔA+ΔB. That is, when ΔF #0, the temperature stability conditions include a condition that the length of extension in the Z-axis direction per unit temperature of a part of the temperature compensation member 50 from the first portion 51 to the second portion 52 differs from the length of extension in the Z-axis direction per unit temperature of a part of the lens barrel 40 closer to the positive side of the Z-axis than a part of the lens barrel 40 in contact with the first portion 51 of the temperature compensation member 50. The following will describe a specific structure example that meets the temperature stability conditions when ΔF+0.

In the structure example in FIG. 1, the first portion 51 of the temperature compensation member 50 is connected to the lens barrel 40 at a position (position closer in the negative direction of the Z-axis) farther from the lens barrel 40 side (positive side of the Z-axis) connected to the substrate 82 than the second portion 52.

When ΔF>0 (when the focal length F becomes longer due to a rise in the temperature) regardless of whether ΔT is positive or negative (whether the temperature rises or falls), the lens unit 10 is formed to satisfy the inequality ΔA>ΔB. The amount of change in a length (D) of a part of the temperature compensation member 50 from the first portion 51 to the second portion 52 may be decreased to degrease ΔB. Specifically, the linear expansion coefficient in the Z-axis direction of the temperature compensation member 50 may be smaller than the linear expansion coefficient in the Z-axis direction of the lens barrel 40.

When ΔF<0 (when the focal length F becomes shorter) regardless of whether ΔT is positive or negative (the temperature rises or falls), the lens unit 10 is formed to satisfy the inequality ΔA<ΔB. The amount of change in the length (D) of a part of the temperature compensation member 50 from the first portion 51 to the second portion 52 may be increased to increase ΔB. Specifically, the linear expansion coefficient in the Z-axis direction of the temperature compensation member 50 may be greater than the linear expansion coefficient in the Z-axis direction of the lens barrel 40. The ratio of B to A (B/A) may be increased to increase ΔB. The length of the temperature compensation member 50 in the Z-axis direction may be increased to increase the value of B/A.

The conditions described above are summarized as follows: to meet the temperature stability conditions, when the focal length F becomes longer due to a rise in temperature, the length of extension in the Z-axis direction per unit temperature of a part (D) of the temperature compensation member 50 from the first portion 51 to the second portion 52 may be smaller than the length of extension in the Z-axis direction per unit temperature of a part of the lens barrel 40 closer to the lens barrel 40 side (positive side of the Z-axis) connected to the substrate 82 than a part of the lens barrel 40 in contact with the first portion 51 of the temperature compensation member 50. To meet the temperature stability conditions, when the focal length F becomes shorter due to a rise in temperature, the length of extension in the Z-axis direction per unit temperature of the part (D) of the temperature compensation member 50 from the first portion 51 to the second portion 52 may be greater than the length of extension in the Z-axis direction per unit temperature of a part of the lens barrel 40 closer to the lens barrel 40 side (positive side of the Z-axis) connected to the substrate 82 than a part of the lens barrel 40 in contact with the first portion 51 of the temperature compensation member 50.

In both cases of ΔF>0 and ΔF<0, to meet the temperature stability conditions, the linear expansion coefficient in the Z-axis direction of the temperature compensation member 50 may differ from the linear expansion coefficient in the Z-axis direction of the lens barrel 40 in the lens unit 10. When ΔF>0, to meet the temperature stability conditions, the linear expansion coefficient in the Z-axis direction of the temperature compensation member 50 may be smaller than the linear expansion coefficient in the Z-axis direction of the lens barrel 40. In other words, when the position (focal position) of the focus 20F of the lens 20 moves toward the image (ΔF>0) due to a rise in temperature, the linear expansion coefficient of the material of the lens barrel 40 may be greater than the linear expansion coefficient of the material of the temperature compensation member 50. When ΔF<0, to meet the temperature stability conditions, the linear expansion coefficient in the Z-axis direction of the temperature compensation member 50 may be greater than the linear expansion coefficient in the Z-axis direction of the lens barrel 40.

As described above, the imaging device 1 and the lens unit 10 according to the embodiment can reduce the effects of temperature changes on the focus performance of the imaging device 1 by controlling changes in the lengths of components in the direction parallel to the optical axis 20A due to temperature changes. As a result, the imaging device 1 and the lens unit 10 according to the embodiment can have improved stability of performance against changes in environmental temperature.

### OTHER EMBODIMENTS

### Other Embodiments Will be Described Below

### Other Structure Examples of the Lens 20

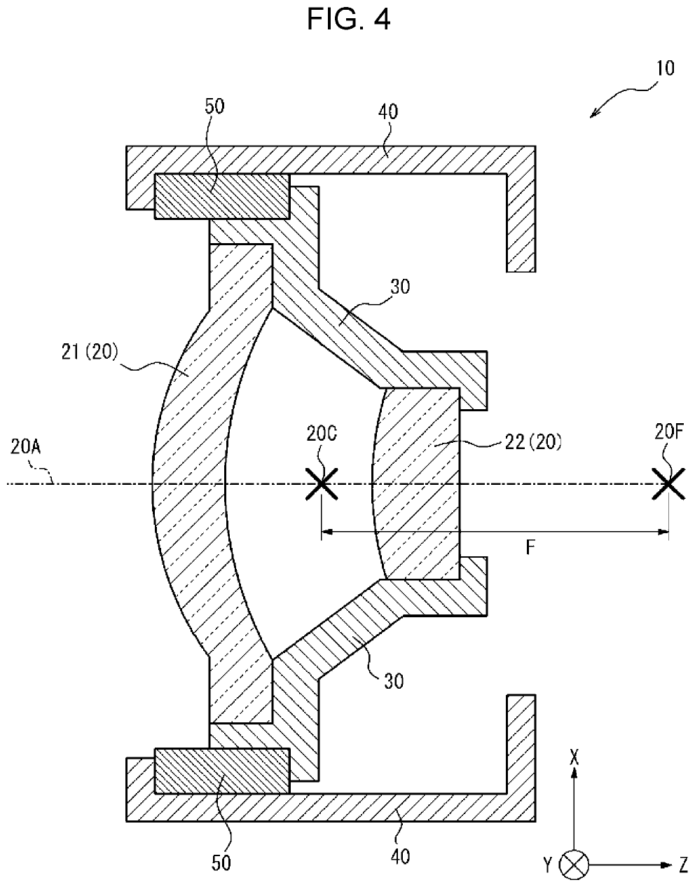

As illustrated in FIG. 4, the lens 20 may include a first lens 21 and a second lens 22. The first lens 21 and the second lens 22 are assumed to be held by the lens frame 30. The structure of the lens 20 is not limited to the examples illustrated in FIG. 1 or 4 and may be various other structures. For example, the number of the lenses 20 is not limited to one or two and may be three or more.

In the embodiment, even when the lens 20 includes a plurality of lenses 20, the lenses 20 are considered to be one integrated lens 20. In the example of FIG. 4, since the first lens 21 and the second lens 22 are considered to be one integrated lens 20, the lenses 20 including the first lens 21 and the second lens 22 are considered to have one lens center 20C. The lenses 20 including the first lens 21 and the second lens 22 are considered to have one focus 20F. The position of each of the lens center 20C and the focus 20F is determined as one point in accordance with the optical characteristics of the first lens 21 and the second lens 22. The focal length F is considered to be the length from the lens center 20C to the focus 20F when the first lens 21 and the second lens 22 are considered as the integrated lens 20. That is, the focal length F of the lenses 20 including the first lens 21 and the second lens 22 is determined in a structure in which the first lens 21 is combined with the second lens 22.

When the plurality of lenses 20 held by the lens frame 30 is considered as the integrated lens 20, the structure of the lens unit 10 described above can be easily applied. Specifically, when the focal length F of the integrated lens 20 changes, the position of the lens frame 30 can be adjusted by changing the values of A and B.

When the lenses 20 include the first lens 21 and the second lens 22, the characteristics of the lenses 20 change because the lens frame 30 itself changes in the Z-axis direction. Specifically, when the distance between the first lens 21 and the second lens 22 changes in response to a temperature change, the focal length F may change. That is, when the length of the lens frame 30 in the Z-axis direction changes in response to a temperature change, the focal length F may change. The structure of the lens unit 10, such as the linear expansion coefficient in the Z-axis direction of the temperature compensation member 50, can be further determined in accordance with the linear expansion coefficient in the Z-axis direction of the lens frame 30. For example, when the temperature rises, the distance between the first lens 21 and the second lens 22 increases. The linear expansion coefficient in the Z-axis direction of the temperature compensation member 50 may be determined in consideration of the effect of an increase in the distance between the first lens 21 and the second lens 22 on the amount (ΔF) of change in the focal length F.

When the temperature compensation member 50 expands more than the lens barrel 40 during the temperature rise, the distance between the second lens 22 of the lenses 20 that is located on the image formation side (positive side of the Z-axis) and the imaging element 80 may increase. In this case, the distance between the second lens 22 and the imaging element 80 may be reduced by the second portion 52 of the temperature compensation member 50 pushing the lens frame 30 toward the image formation side (positive side of the Z-axis). That is, the change in the distance between the second lens 22 and the imaging element 80 may be cancelled by the second portion 52 of the temperature compensation member 50 pushing the lens frame 30 toward the image formation side (positive side of the Z-axis).

<Another structure example of temperature compensation member 50>

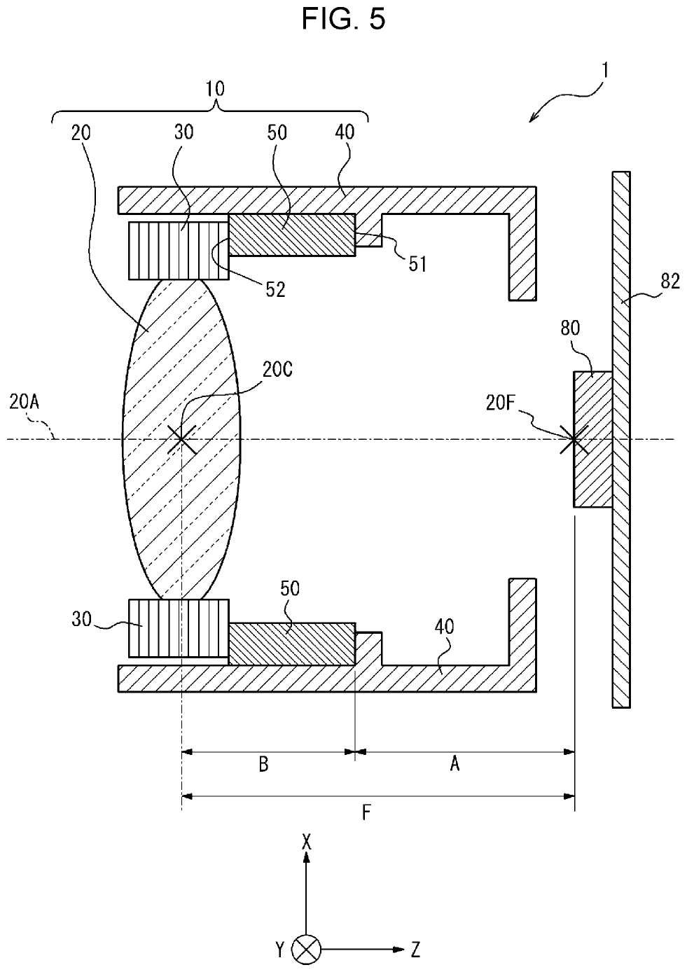

As illustrated in FIG. 5, the first portion 51 of the temperature compensation member 50 may be located closer to the negative side of the Z-axis than the second portion 52. That is, the first portion 51 may be connected to the lens barrel 40 at a position farther from the lens barrel 40 side (positive side of the Z-axis) connected to the substrate 82 than the second portion 52.

When the temperature rises in the example in FIG. 5 (ΔT>0), the temperature compensation member 50 extends in the negative direction of the Z-axis with respect to the first portion 51 as the reference position. That is, when ΔT>0, ΔB<0 holds. When the focal length F becomes longer due to a rise in temperature (ΔF>0), to meet the temperature stability conditions, the lens unit 10 may be formed to make the sum of ΔA and the absolute value of ΔB (ΔA+|ΔB|) equal ΔF or approach ΔF.

### Examples of Materials of Components

The lens frame 30 and the lens barrel 40 may include, for example, aluminum alloy as a material. The material of the lens frame 30 and the lens barrel 40 is not limited to aluminum alloy and may include other various materials. A material of the lens frame 30 may differ from a material of the lens barrel 40. That is, in the lens unit 10, the material of at least a part of the lens frame 30 may be different from the material of at least a part of the lens barrel 40.

The temperature compensation member 50 may include, for example, acrylonitrile butadiene styrene (ΔBS) novalloy as a material. The material of the temperature compensation member 50 may be selected such that the linear expansion coefficient in the Z-axis direction of the temperature compensation member 50 differs from the linear expansion coefficient in the Z-axis direction of the lens barrel 40.

### Usage Example of Imaging Device 1 and Lens Unit 10

The imaging device 1 and the lens unit 10 according to the embodiment may be used in a device disposed in an environment in which temperature changes significantly. The imaging device 1 and the lens unit 10 may be mounted in a moving body, such as an automobile.

The diagrams for describing embodiments of the present disclosure are schematic. The dimensional ratios and the like on the drawings do not necessarily match the actual ones. Although the embodiments of the present disclosure have been described with reference to various drawings and examples, note that those skilled in the art can make various changes or modifications in accordance with the present disclosure. Thus, note that these changes or modifications fall within the scope of the present disclosure. For example, functions and the like included in components can be rearranged so as not to be logically contradictory, and a plurality of components and the like can be combined into one or divided. Note that these are also included in the scope of the present disclosure.

The descriptions such as “first” and “second” in the present disclosure are identifiers for distinguishing individual components. In the components distinguished by “first”, “second”, and the like in the present disclosure, the ordinal numbers of the components can be exchanged with each other. For example, the identifier “first” of the first portion 51 and the identifier “second” of the second portion 52 can be exchanged with each other. The identifiers can be exchanged with each other at the same time. The components are be distinguished from each other even after the identifiers are exchanged with each other. The identifiers may be deleted. The components from which the identifiers have been deleted are distinguished by reference numerals. The order of the components cannot be represented and the existence of smaller-number identifiers cannot be proved in accordance with only identifiers, such as “first” and “second” in the present disclosure.

In the present disclosure, the X-axis, Y-axis, and Z-axis are provided for convenience of description and may be exchanged with each other. The components according to the present disclosure have been described by using a Cartesian coordinate system including the X-axis, the Y-axis, and the Z-axis. The positional relationship between components according to the present disclosure is not limited to having an orthogonal relationship.

### REFERENCE SIGNS

1 imaging device
10 lens unit
20 lens (20A: optical axis, 20C: lens center, 20F: focus, 21: first lens, 22: second
lens)
30 lens frame
40 lens barrel
50 temperature compensation member (51: first portion, 52: second portion)
80 imaging element (82: substrate)

1. lens unit comprising:
a lens that has an optical axis;
a lens frame holding the lens;
a lens barrel that has a central axis along the optical axis, houses the lens frame on an inner circumferential side, and is connectable to a substrate on which an imaging element is mounted; and
a temperature compensation member that comprises a first portion and a second portion that are apart from each other in a direction parallel to the optical axis,
wherein the first portion of the temperature compensation member is in contact with the lens barrel and the second portion of the temperature compensation member is in contact with the lens frame,
by the lens frame being connected to the lens barrel via the temperature compensation member, the lens frame is movable in the direction parallel to the optical axis with respect to the lens barrel when a length of the temperature compensation member in the direction parallel to the optical axis changes, and
a length of extension in the direction parallel to the optical axis per unit temperature of a part of the temperature compensation member from the first portion to the second portion differs from a length of extension in the direction parallel to the optical axis per unit temperature of a part of the lens barrel closer to a lens barrel side connected to the substrate than a part of the lens barrel in contact with the first portion of the temperature compensation member.

2. The lens unit according to claim 1,
wherein the first portion of the temperature compensation member is connected to the lens barrel at a position farther from the lens barrel side connected to the substrate than the second portion of the temperature compensation member,
when a focal length of the lens becomes longer due to a rise in temperature, the length of extension in the direction parallel to the optical axis per unit temperature of the part of the temperature compensation member from the first portion to the second portion is smaller than the length of extension in the direction parallel to the optical axis per unit temperature of the part of the lens barrel closer to the lens barrel side connected to the substrate than the part of the lens barrel in contact with the first portion of the temperature compensation member, and
when the focal length of the lens becomes shorter due to a rise in temperature, the length of extension in the direction parallel to the optical axis per unit temperature of the part of the temperature compensation member from the first portion to the second portion is smaller than a length of extension in the direction parallel to the optical axis per unit temperature of a part of the lens barrel closer to the lens barrel side connected to the substrate than a part of the lens barrel in contact with the second portion of the temperature compensation member.

3. The lens unit according to claim 1,
wherein, in the direction parallel to the optical axis, a linear expansion coefficient of the temperature compensation member differs from a linear expansion coefficient of the lens barrel.

4. The lens unit according to claim 3,
wherein a position at which the first portion of the temperature compensation member is connected to the lens barrel is farther from the lens barrel side connected to the substrate than a position at which the second portion of the temperature compensation member is connected to the lens barrel,
when a focal length of the lens becomes longer due to a rise in temperature, the linear expansion coefficient in the direction parallel to the optical axis of the temperature compensation member is smaller than the linear expansion coefficient in the direction parallel to the optical axis of the lens barrel, and
when the focal length of the lens becomes shorter due to a rise in temperature, the linear expansion coefficient in the direction parallel to the optical axis of the temperature compensation member is greater than the linear expansion coefficient in the direction parallel to the optical axis of the lens barrel.

5. The lens unit according to claim 3,
wherein a material of at least a part of the lens frame differs from a material of at least a part of the lens barrel.

6. The lens unit according to claim 1,
wherein the lens comprises at least a first lens and a second lens, and
a focal length of the lens is determined in a structure in which the first lens is combined with the second lens.

7. The lens unit according to claim 1,
wherein, when the lens barrel is connected to the substrate, a focus of the lens is formed on an imaging surface of the imaging element at least at a predetermined temperature.

8. The lens unit according to claim 1,
wherein at least one selected from the group consisting of the first portion and the second portion of the temperature compensation member is a plane that intersects the direction parallel to the optical axis.

9. An imaging device comprising:
a lens unit; and
a substrate on which an imaging element is mounted,
wherein the lens unit comprises
a lens that has an optical axis,
a lens frame holding the lens,
a lens barrel that has a central axis along the optical axis, houses the lens frame on an inner circumferential side, and is connected to the substrate, and
a temperature compensation member that comprises a first portion and a second portion that are apart from each other in a direction parallel to the optical axis,
the first portion of the temperature compensation member is in contact with the lens frame and the second portion of the temperature compensation member is in contact with the lens barrel,
by the lens frame being connected to the lens barrel via the temperature compensation member, the lens frame is movable in the direction parallel to the optical axis with respect to the lens barrel when a length of the temperature compensation member in the direction parallel to the optical axis changes, and
a length of extension in the direction parallel to the optical axis per unit temperature of a part of the temperature compensation member from the first portion to the second portion differs from a length of extension in the direction parallel to the optical axis per unit temperature of a part of the lens barrel closer to a lens barrel side connected to the substrate than a part of the lens barrel in contact with the second portion of the temperature compensation member.

10. The lens unit according to claim 2,
wherein, in the direction parallel to the optical axis, a linear expansion coefficient of the temperature compensation member differs from a linear expansion coefficient of the lens barrel.

11. The lens unit according to claim 10,
wherein a position at which the first portion of the temperature compensation member is connected to the lens barrel is farther from the lens barrel side connected to the substrate than a position at which the second portion of the temperature compensation member is connected to the lens barrel,
when a focal length of the lens becomes longer due to a rise in temperature, the linear expansion coefficient in the direction parallel to the optical axis of the temperature compensation member is smaller than the linear expansion coefficient in the direction parallel to the optical axis of the lens barrel, and
when the focal length of the lens becomes shorter due to a rise in temperature, the linear expansion coefficient in the direction parallel to the optical axis of the temperature compensation member is greater than the linear expansion coefficient in the direction parallel to the optical axis of the lens barrel.

12. The lens unit according to claim 10,
wherein a material of at least a part of the lens frame differs from a material of at least a part of the lens barrel.

13. The lens unit according to claim 11,
wherein a material of at least a part of the lens frame differs from a material of at least a part of the lens barrel.
